(19) United States
(12) Patent Application Publication
(10) Pub. No.: US 2008/0038427 A1
(43) Pub. Date: Feb. 14, 2008

(54) Method for adding slits to expose fruit filling in a co-extruded bar

(75) Inventor: Adi Tya Varanasi, Streamwood, IL (US)

Correspondence Address: PEPSICO, INC.;c/o GOODWIN PROCTER LLP, 599 LEXINGTON AVE, NEW YORK, NY, 10022, US

(73) Assignee: The Quaker Oats Company, Chicago, IL (US)

(21) Appl. No.: 11/585,384

(22) Filed: Oct. 24, 2006

Related U.S. Application Data
(60) Provisional application No. 60/836,476, filed on Aug. 9, 2006.

(51) Int. Cl. A23L 1/00

(52) U.S. Cl. 426/516

(57) ABSTRACT

The present invention is directed towards methods and apparatus for modifying the exterior structure of a co-extruded bar type food product, and products formed thereby. By lowering a blade into the outer dough jacket of a food bar, as it is extruded, a slit can be created in the outer jacket of the bar. This can expose the interior filling of the bar at the slit portions, aiding in identification of the fruit flavoring and improving the aesthetics of the finished bar.

### CROSS-REFERENCE TO RELATED APPLICATIONS

This application claims priority to and the benefit of U.S. provisional patent application Ser. No. 60/836,476, filed Aug. 9, 2006, the disclosure of which is being incorporated herein by reference in its entirety.

### FIELD OF THE INVENTION

The present invention relates generally to the field of food production, and more particularly to a method and apparatus for modifying a bar type food product during extrusion.

### BACKGROUND OF THE INVENTION

Snack bars, such as fruit and oatmeal bars, may be formed with an outer layer surrounding a central portion formed from a different material. For example, the outer layer of a snack bar may be formed from a dough jacket, or an outer covering formed from oatmeal embedded in a bonding material, such as, but not limited to, a sugar based syrup. The central portion of the snack bar may include a fruit filling (either as a solid or a jam), an oatmeal filling (possibly with fruit or other materials embedded within the oatmeal), or another appropriate snack food filling.

One method of forming such a snack bar may involve a co-extrusion process. In this process, the outer layer is formed around the central portion in an extrusion machine, after which the formed material is extruded from the extrusion machine as a long cylinder of snack food precursor material. This cylinder of snack food precursor can then be cooled and cut into sections to produce the final snack food product, at which time it can be packaged ready for distribution.

One problem with this method is that once the outer layer has formed about the central portion, an observer cannot tell what filling material in the center of the snack bar consists of without cutting into the bar. As a result, consumers cannot observe for themselves what the center of the snack bar may look like prior to purchase, and therefore may be discouraged from trying a snack bar which they are not familiar with. It would, therefore, be helpful to remove at least one small portion of the outer layer of the finished snack food product to allow a consumer to view the interior of the snack food product to observe first hand the color, flavor, and texture of the center of the snack food product prior to purchasing.

Standard co-extrusion equipment, such as bar cutters and ultrasonic cutters, are not designed to provide shallow cuts to only remove a small portion of a single layer of an extruded snack food product. As a result, this apparatus may be difficult to align and setup for the task of providing these shallow slits, and may also have difficulty performing consistently a task they are not specifically designed for. For example, the use of bar cutters for such a task may result in a build up of fruit filing or other material on the blade of the cutter, thus potentially reducing the effectiveness of the blade, while also resulting in the blade needing regular cleaning. Standard bar cutters and ultrasonic cutters are therefore ill-suited for the purpose of providing a slit in the outer layer of a co-extruded snack food product.

As such, there is a need to provide a simple apparatus and method for consistently, robustly, and cleanly creating slits in a co-extruded snack food product with minimal disturbance to the central portion of the extruded material.

### SUMMARY OF THE INVENTION

The present invention provides a method and apparatus for adding slits to a multi-layer snack food product during co-extrusion manufacturing, and a product produced thereby. These slits, cavities, or openings, can expose the inner portion of the snack food product, allowing a consumer to see the center of the bar prior to purchasing. This can aid in the determination of the flavor and texture of the center of the bar, while also providing the bar with a more “home-style” look.

In one aspect, the invention relates to a method for creating a shallow cavity in an extruded snack food product. The snack food product precursor can include an outer layer and at least one inner layer. The method can include the steps of extruding a snack food product precursor from an extrusion machine, lowering a blade into one side of the extruding precursor to the depth of the boundary between the outer layer and the at least one inner layer of the precursor, holding the blade in place for a set time while the precursor material continues to be extruded from the extrusion machine, and retracting the blade from the precursor material, thus leaving a portion of the inner layer of the precursor uncovered. The outer layer and the at least one inner layer of the snack food product precursor may comprise different materials.

The outer layer of the snack food product can include a material selected from the group consisting of a dough, a paste, a syrup, and an outer covering formed from oatmeal embedded in a bonding material. The at least one inner layer of the snack food product can include a material selected from the group consisting of a fruit preserve, an oatmeal based mixture, a nut based filling, a cake, a dough, a syrup, a candy, and a nougat. The blade may be lowered linearly into the extruding precursor, or be lowered rotationally into the extruding precursor. The blade may include a plurality of teeth.

In another aspect, the invention relates to a snack food product including at least one inner layer and an outer layer comprising at least one slit. The at least one slit can be formed from a method including the steps of extruding a snack food product precursor from an extrusion machine, lowering a blade into one side of the extruding precursor to the depth of the boundary between the outer layer and the at least one inner layer of the precursor, holding the blade in place for a set time while the precursor material continues to be extruded from the extrusion machine, and retracting the blade from the precursor material, thus leaving a portion of the inner layer of the precursor uncovered to form the slit.

The outer layer and the at least one inner layer of the snack food product precursor can be made from different materials. The outer layer of the snack food product can include a material selected from the group consisting of a dough, a paste, a syrup, and an outer covering formed from oatmeal embedded in a bonding material. The at least one inner layer of the snack food product can include a material selected from the group consisting of a fruit preserve, an oatmeal based mixture, a nut based filling, a cake, a dough, a syrup, a candy, and a nougat. The outer layer can include a plurality of slits.

In another aspect, the invention relates to an apparatus for creating a shallow cavity in an extruded snack food product. The apparatus can include a blade, a control system, and a driver. The driver can move the blade between a first position clear of the extruded snack food product and a second position at least partially obstructing the extrusion of the snack food product in response to a signal from the control system.

The blade can at least partially abut a surface of an extrusion machine, or be located within an extrusion machine. The blade can include a plurality of teeth. The blade can be configured to extend linearly between the first position and second position, or be configured to rotate about an axis between the first position and second position. The blade can be moved between the first position and second position for a set time in response to a signal from the control system.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a schematic perspective view of a slit blade engaging a snack bar during extrusion, in accordance with one embodiment of the invention;

FIG. 2 is a schematic cross-sectional side view of the extrusion process of FIG. 1;

FIG. 3A is a schematic side view of a vertically slideable slit blade, in accordance with one embodiment of the invention;

FIG. 3B is a schematic side view of a rotatable slit blade, in accordance with one embodiment of the invention;

FIG. 4A is a schematic side view of a vertically aligned slit blade engaging a snack bar, in accordance with one embodiment of the invention;

FIG. 4B is a schematic side view of an obtusely angled slit blade engaging a snack bar, in accordance with one embodiment of the invention;

FIG. 4C is a schematic side view of an acutely angled slit blade engaging a snack bar, in accordance with one embodiment of the invention;

FIG. 5 is a schematic perspective view of a slotted slit blade engaging a snack bar during extrusion, in accordance with an alternative embodiment of the invention;

FIG. 6A is a schematic side view of a slit blade abutting the end of an extrusion device, in accordance with one embodiment of the invention;

FIG. 6B is a schematic side view of a slit blade located within an extrusion device, in accordance with one embodiment of the invention;

FIGS. 7A-7C are schematic side views of alternative embodiments of a slit blade in accordance with the invention; and

FIG. 8 is a schematic perspective view of two slit blades engaging a snack bar during extrusion, in accordance with another alternative embodiment of the invention.

### DETAILED DESCRIPTION

In one embodiment of the invention, a multi-layer snack food product precursor is extruded from an extrusion machine in the form of a single, long bar, with an outer layer surrounding one or more inner portions. A cross-section of the bar may be substantially rectangular, square, oblong, circular, or any other appropriate shape.

The outer layer of a snack food product may be formed from a dough jacket, an outer covering formed from oatmeal embedded in a bonding material (such as, but not limited to, a sugar based syrup), or any other appropriate outer covering. The central portion of the snack bar may include a fruit filling (either as a solid or a jam), an oatmeal filling (possibly with fruit or other materials embedded within the oatmeal), or another appropriate snack food filling. Fat, carbohydrate, and protein based filings are also contemplated and are within the scope of the invention.

As the snack food product is extruded from an extrusion machine, the outer portion and/or the inner portion of the snack food product may not have set into a final form, but rather still be setting and/or cooling from a precursor form into a final, set form. While in this precursor form, the materials comprising the outer layer and inner layer may be soft, pliable, and easily cut and/or deformable.

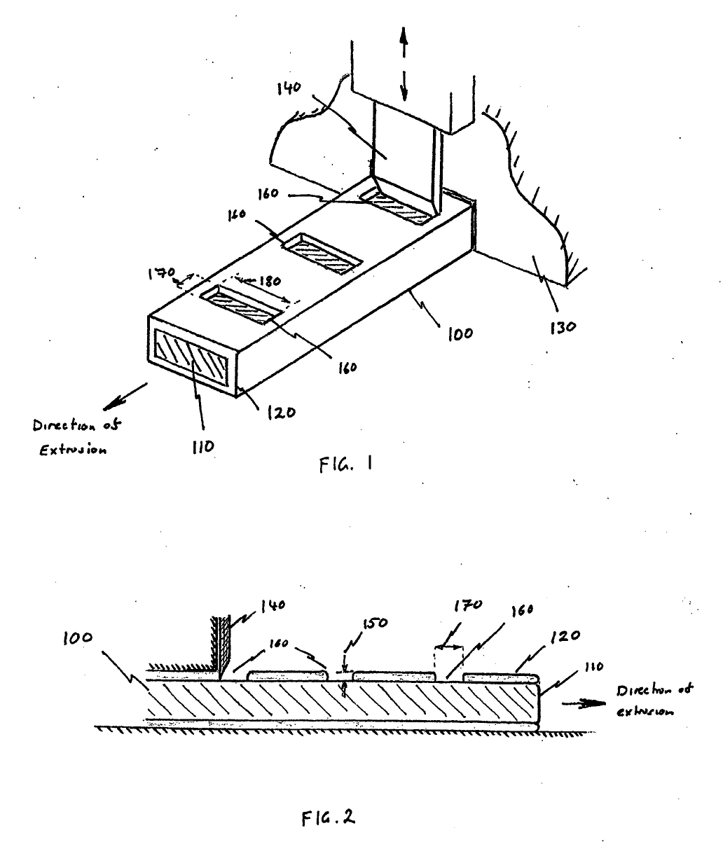

As the snack food product precursor is extruded from the extrusion machine, a slit blade may be lowered into the outer layer of the product precursor to block the outer layer for a brief period and, therefore, expose a portion of the center of the snack food. An example of this embodiment can be seen in FIGS. 1 and 2.

In this embodiment, a snack food product precursor 100 including an inner layer 110 and an outer layer 120 is extruded from an extrusion machine 130 in the form of a long single bar of material. As the product precursor 100 is extruded, a slit blade 140 may be lowered into the material to block a portion of the material from leaving the extrusion machine 130. The depth 150 to which the slit blade 140 projects into the material can be accurately controlled to allow the slit blade 140 to block all of a portion of the outer layer 120 while leaving the inner portion 110 of the food product substantially untouched.

As the product precursor 100 continues to be extruded, the positioning of the slit blade 140 will have the effect of producing a cavity 160 behind the slit blade 140, exposing the inner portion 110 of the material within that cavity 160. The length 170 of the cavity 160 can be controlled by holding the slit blade 140 in place for a given length of time and then removing it from the material. If the snack food product 100 is extruded from the extrusion machine 130 at a constant velocity, then the length of the cavity 160 is linearly related to the length of time the slit blade 140 is held within the outer layer 120 of the product precursor 100. Lengthening the time that the slit blade 140 is held in place will result in a longer cavity 160, while shortening the time will result in a shorter cavity 160. In an alternative embodiment, the length 170 of the cavity 160 formed within the food product precursor 100 can be varied by holding the slit blade 140 within the outer layer 120 of the material for a set length of time, while varying the extrusion speed of the material.

The width 180 of the cavity 160 is determined by the width of the slit blade 140. As a result, cavities of different widths can be created easily by using slit blades of greater of lesser width. The depth of the cavity 160 can be increased or decreased by simply changing the distance by which the slit blade 140 is lowered.

In one embodiment of the invention, the slit blade 140 may be raised and lowered using a motor and gear assembly. The motor may be controlled by an extrusion machine controller, providing accurate, repeatable motion of the slit blade 140. In an alternative embodiment, any other appropriate means of repeatably raising and lowering the slit blade 140 may be utilized. As a result, the depth 150 of travel of the slit blade 140 into the material, the frequency at which the slit blade 140 is lowered (controlling the number and regularity of cavities), and the length of time that the slit blade 140 is lowered for each cavity 160, can be controlled by the motor controller. The slit blade 140 can, therefore, easily be adjusted to create different sized and shaped cavities at different frequencies, as required. The slit blade 140 may be manufactured from a metal, such as, but not limited to, stainless steel or aluminum, a plastic, or any other appropriate food grade material.

The slit blade 140 may be moved in and out of the food product material in a number of different ways. In one embodiment of the invention, as shown in FIG. 3A, the slit blade 140 can be lowered and raised vertically in and out of the food product material. In this embodiment, the depth of the cavity created by the slit blade 140 is controlled by increasing or decreasing the distance of travel of the slit blade 140.

In the embodiment of FIG. 3B, the slit blade 140 can be rotated downwards towards a vertical orientation to engage the food product material, and rotated up away from the material once a cavity has been created. In this embodiment, the depth of the cavity created by the slit blade 140 is controlled by increasing or decreasing the angular distance of rotation of the slit blade 140 around its axis of rotation. As such, increasing the angular distance of rotation, resulting in the slit blade 140 approaching a more vertical orientation, will increase the depth of the cavity. The maximum depth of the cavity will be created when the slit blade 140 is rotated into a fully vertical orientation.

In the embodiments of FIGS. 3A and 3B, the motion of the slit blade 140 can be controlled by a motor and gear assembly engaging the slit blade 140. The motor may be connected to the extrusion machine controller, or another appropriate controller (such as, but not limited to, a PC), to control the slit blade 140 for a specific run and/or product. Any other appropriate mechanical and/or electrical means of controlling the motion of the slit blade may also be utilized.

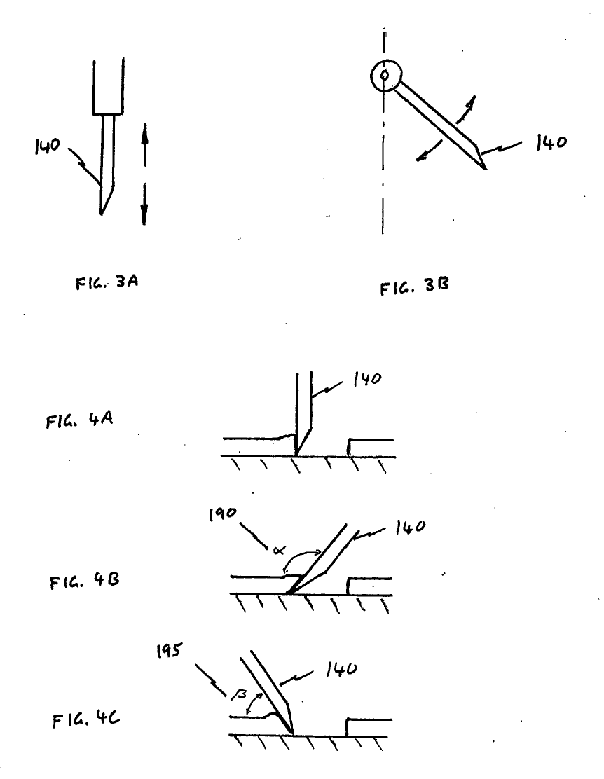

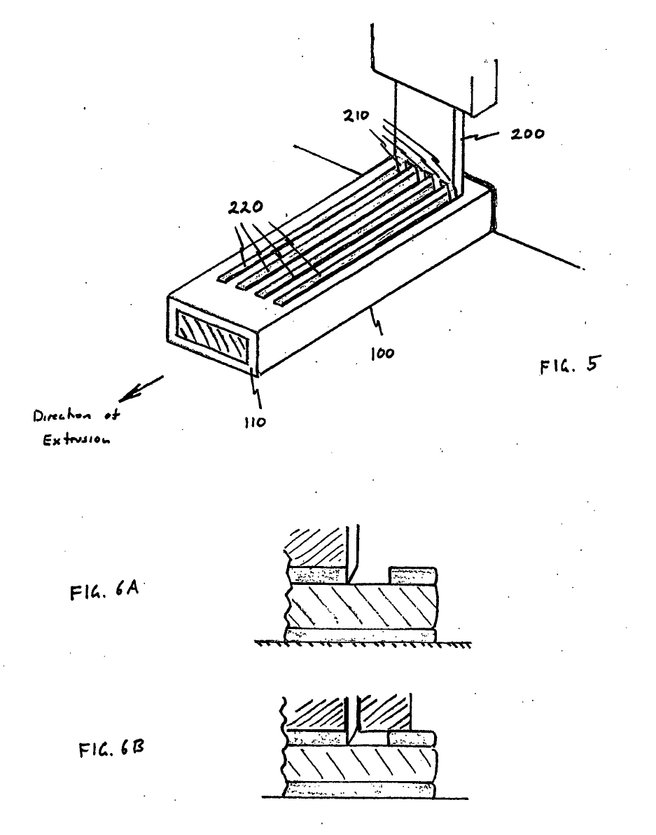

The angle at which the slit blade impacts the outer layer of the food product precursor 100 may also be varied. Example impact angles are shown in FIGS. 4A to 4C. In FIG. 4A, the slit blade 140 enters the outer layer vertically at 90° to the surface of the outer layer 120 of the food product material. In FIG. 4B the slit blade 140 enters the outer layer of the food product material at an obtuse angle α 190, while in FIG. 4C the slit blade 140 enters the outer layer of the food product material at an acute angle β 195.

In one embodiment of the invention, a slit blade may be formed in different shapes, to provide differently shaped cavities within the final food product. An example of an alternative slit blade can be seen in FIG. 5. In this embodiment, the slit blade 200 includes a number of different teeth 210 (in this case four). As a result, rather than creating one cavity across the width of the outer layer 110 of the food product precursor 100, the slit blade 200 can create a number of parallel cavities 220. As before, the length and depth of these cavities can be controlled depending upon the specific requirements of the operator or on the specific snack bar material being extruded. In an alternative embodiment, a greater or lesser number of teeth 210 may be used within the slit blade 200. In a further alternative embodiment, the teeth of the slit blade 200 may be shaped differently to provide different shapes of cavity in the final food product. In one example embodiment, the teeth 210 of the slit blade 200 may be “V” shaped.

In an alternative embodiment, the shape of the slit blade may also be changed. For example, the slit blade may be manufactured from a sheet of metal as a simple rectangular plate, or be fashioned with a sharp or curve edge, as required. In a further alternative embodiment, the slit blade may be slideable across the width of the extruded food product precursor 100, allowing slits to be created at different locations across the width of the food product, as required by a user.

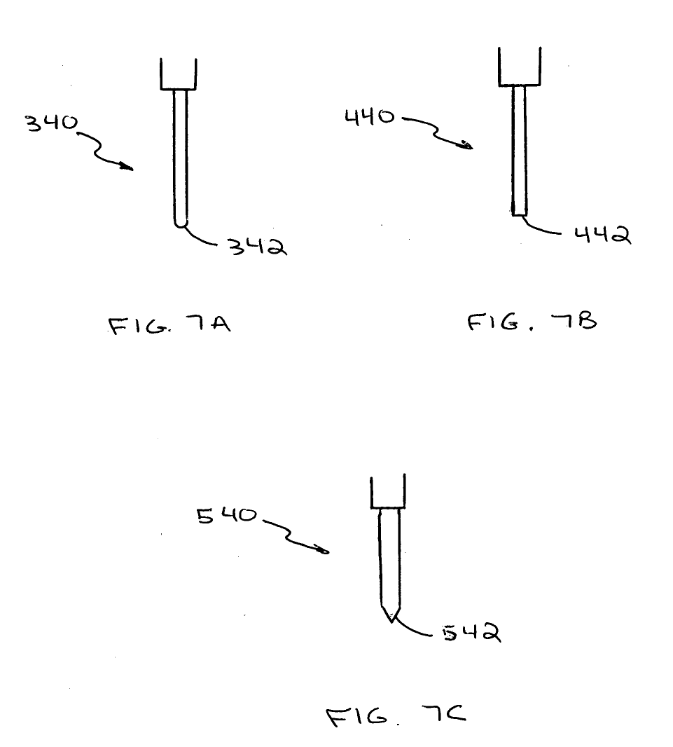

In the above embodiments of the invention, the slit blade was located outside the exit of the extrusion machine; however, the slit blade may also be located at other locations within the extrusion process to create the slit cavities. Example slit blade locations are shown in FIGS. 6A and 6B. In the embodiment of FIG. 6A, a slit blade 300 is placed directly against the outer wall of the extrusion machine 130, such that there is no gap between the end of the extrusion machine and the slit blade when it is lowered into position. The advantage of this embodiment is that there would be no gap for the outer layer 120 material blocked by the slit blade 300 to expand into, and as a result there would be substantially no disturbance to the thickness of the outer layer directly behind a cavity.

In the embodiment of FIG. 6B, the slit blade 300 is located within the extrusion machine 130 itself. Again, this would leave no gap for the outer layer 120 material blocked by the slit blade 300 to expand into. Post processing of the food product, such as packaging, cooking or otherwise processing, after extrusion may occur within the machine or as the food product exits the extruder.

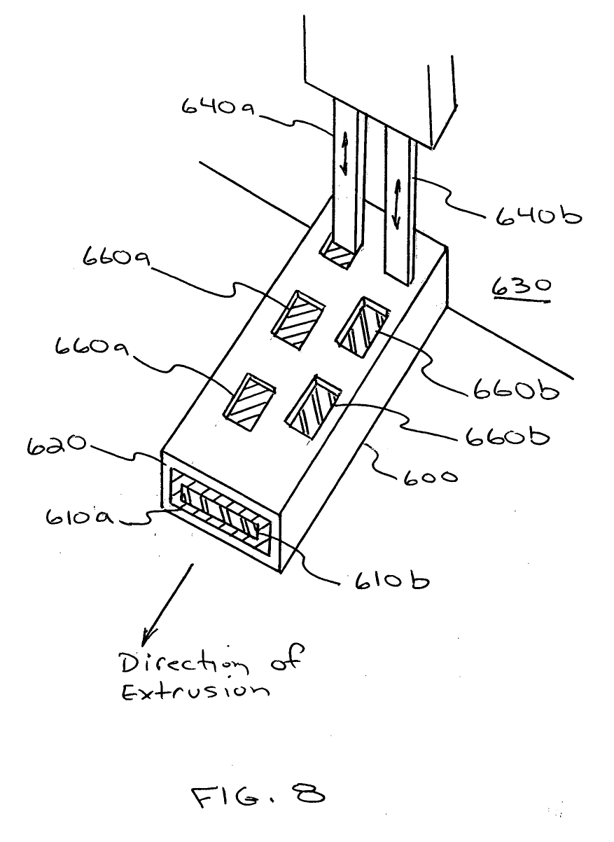

FIGS. 7A to 7C depict slit blades 340, 440, 540 having alternative tips 342, 442, 542. As shown in FIG. 7A, the slit blade 340 includes a rounded tip 342, while FIG. 7B depicts a slit blade 440 with a square tip 442. The slit blade tip may be sharp or blunt as necessary for a specific application. For example, harder material layers may require a sharper tip. The slit blade 540 depicted in FIG. 7C has a double-beveled tip 542. The slit blade tip can have essentially any shape, including flat and arcuate surfaces, as necessary to suit a particular application.

In an alternative embodiment of the invention, the snack food product may include a plurality of inner layers, with one or more intermediate layers being placed between the outer layer and the central portion. In this embodiment, a slit blade may be configured to provide a slit down to the boundary of any one of the inner layers. In an alternative embodiment, the depth of the slit blade may be varied such that different slits provide a view of the surface of different interior layers, allowing a consumer to view all the materials making up the snack food product. Multiple layered food products may be produced by, for example, triple or quadruple extrusion processes. Additionally, multiple slit blades may be used to provide openings or varying shape and depth, as shown in FIG. 8.

FIG. 8 depicts an alternative embodiment of the invention, where the food product precursor 600 is triple extruded by the extruder machine 630, thus providing two inner layers 610a, 610b. The inner layers 610a, 610b are depicted as generally concentric; however, the layers 610 do not need to have a common center axis or surround each other. The food product precursor 600 includes an outer layer 620 and can be produced from any of the materials described hereinabove. In the depicted embodiment, two slit blades 640a, 640b are utilized; however, any practicable number, size, or shape of slit blades 640 could be used. Generally, the slit blades 640a, 640b are operated as described hereinabove; however, the depicted slit blades 640a, 640b can be used to produce cavities 660a, 660b of varying depths to show the different multiple layers within the food product precursor 600. Additionally, the slit blades 640a, 640b can be controlled to produce cavities 660 in a variety of patterns, such as, for example, staggered along the length of the food precursor 600, as shown in FIG. 8.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for creating at least one shallow cavity in an extruded snack food product, the method comprising the steps of:
extruding a snack food product precursor from an extrusion machine, wherein the snack food product precursor includes an outer layer and at least one inner layer;
lowering a blade into one side of the extruding precursor to the depth of the boundary between the outer layer and the at least one inner layer of the precursor;
holding the blade in place for a set time while the precursor material continues to be extruded from the extrusion machine; and
retracting the blade from the precursor material, thus leaving a portion of the inner layer of the precursor uncovered.

2. The method of claim 1, wherein the outer layer and the at least one inner layer of the snack food product precursor comprise different materials.

3. The method of claim 1, wherein the outer layer of the snack food product comprises a material selected from the group consisting of a dough, a paste, a syrup, and an outer covering formed from oatmeal embedded in a bonding material.

4. The method of claim 1, wherein at least one inner layer of the snack food product comprises a material selected from the group consisting of a fruit preserve, an oatmeal based mixture, a nut based filling, a cake, a dough, a syrup, a candy, and a nougat.

5. The method of claim 1, wherein the blade is lowered linearly into the extruding precursor.

6. The method of claim 1, wherein the blade is lowered rotationally into the extruding precursor.

7. The method of claim 1, wherein the blade comprises a plurality of teeth.

8. A snack food product comprising:
at least one inner layer; and
an outer layer comprising at least one slit, wherein the at least one slit is formed from a method comprising:
extruding a snack food product precursor from an extrusion machine;
lowering a blade into one side of the extruding precursor to the depth of the boundary between the outer layer and the at least one inner layer of the precursor;
holding the blade in place for a set time while the precursor material continues to be extruded from the extrusion machine; and
retracting the blade from the precursor material, thus leaving a portion of the inner layer of the precursor uncovered to form the slit.

9. The snack food product of claim 8, wherein the outer layer and the at least one inner layer of the snack food product precursor comprise different materials.

10. The snack food product of claim 8, wherein the outer layer of the snack food product comprises a material selected from the group consisting of a dough, a paste, a syrup, and an outer covering formed from oatmeal embedded in a bonding material.

11. The snack food product of claim 8, wherein at least one inner layer of the snack food product comprises a material selected from the group consisting of a fruit preserve, an oatmeal based mixture, a nut based filling, a cake, a dough, a syrup, a candy, and a nougat.

12. The snack food product of claim 8, wherein the outer layer comprises a plurality of slits.
